(19) United States
(12) Patent Application Publication
(10) Pub. No.: US 2016/0334645 A1
(43) Pub. Date: Nov. 17, 2016

(54) Eye glass jewelry system

(71) Applicant: Dorothy A. Canada, Las Vegas, NV (US)

(72) Inventor: Dorothy A. Canada, Las Vegas, NV (US)

(21) Appl. No.: 14/713,565

(22) Filed: May 15, 2015

(51) Int. Cl. G02C 11/02; A44C 25/00

(52) U.S. Cl. CPC G02C 11/02; A44C 25/007; G02C 2200/06

(57) ABSTRACT

This invention is a two part system for decorating the arm of sunglasses or vision glasses. It consists of a strap to be wrapped around the arm of the glasses and a charm or piece of jewelry with a molded back to work in conjunction with the strap.

This is a rubber strap 2½″ long by ¼″ wide that has 3 holes on one End measuring 3/32″ each and 3 nubs on the other end of strap measuring 5/32″ each. Strap thickness is 1/32″. There is a center hole on strap also Measuring 3/32″.

Charms will be molded with the charm back as illustrated in Figure A.

You would push the charm through center hole until it locks in.

Position strap on the arm of either sunglasses or vision glasses. Wrap

Strap around arm of glasses until there is a tight fit. Then push the nub

Into corresponding hole that makes it secure. The excess strap is trimmed

With scissors and you are done installing the “The Eyeglass Jewelry System”.

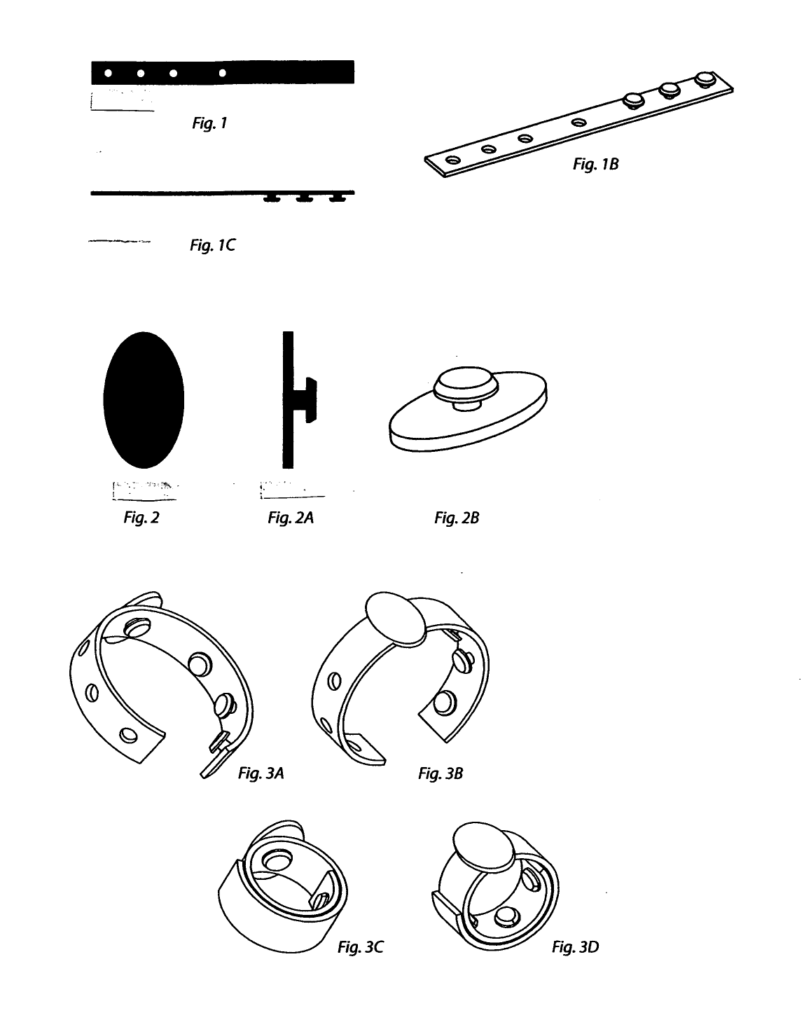

FIG. 1-FIG. 1B-FIG. 1C

This is a silicone strap 2½″ long by ¼″ wide that has 3 holes on one end measuring 3/32″ each and 3 nubs on the other end of strap. Diameter of nub top is 5/32″ Strap thickness is 1/32″. There is a center hole on strap also measuring 3/32″.

FIG. 2 A-FIG. 2B-FIG. 2

Charms will be molded with the charm back illustrated in FIG. 2A with a nub of 5/32″. You would push the charm through center hole until it locks in.

FIG. 3 A-FIG. 3B-FIG. 3C-FIG. 3D

This illustrates how strap will wrap around arm of sunglasses or vision glasses. Position strap on arm of glasses, wrap strap around the arm of glasses until there is a tight fit. Then push the nub into corresponding hole that makes it secure. The excess strap is trimmed with scissors and you are done installing “The Eyeglass Jewelry System”

1. Eye glass jewelry system consists of a silicone strap containing 3 holes on one end and 3 nubs on other end to form a secure fit when wrapped around the arm of either vision glasses or sunglasses and locked into place. FIG. 1 illustrates front view of strap consisting of a center hole which will hold a charm fitted with a molded back, as illustrated in claim #2 and 3 holes for making it secure on arm of glasses.
FIG. 1C illustrates the side view of the strap showing the nubs that will be inserted into holes on other end of strap making a secure fit.
FIG. 1B illustrates top view of strap.
FIG. 2A illustrates side view of molded nub manufactured on to charms or jewelry to be inserted into center hole of strap.
FIG. 2B illustrates top view of molded nub for back of charms or jewelry.
FIG. 2 illustrates back view of molded nub for back of charms or jewelry.
FIG. 3A-FIG. 3B-FIG. 3C-FIG. 3D illustrates strap wrapping around arm of sun or vision glasses to make a secure fit.
After inserting charm with molded back into center hole place strap on desired location on arm of glasses, wrap strap around and push nub into the hole that makes a tight and secure fit. Once this is done excess strap is trimmed with scissors.

2. consists of a molded charm back as illustrated in FIG. 2A FIG. 2B and FIG. 2 to work in conjunction with charm strap as described in claim #1.
Molded charm back is a post molded onto back of charm or jewelry to be inserted into center hole of charm strap as described in claim #1. Charm back makes a secure fit into center hole of strap to display charms or jewelry. This is a two part system for decorating the arm of sunglasses or vision glasses.
